(19) United States
(12) Patent Application Publication
(10) Pub. No.: US 2026/0078262 A1
(43) Pub. Date: Mar. 19, 2026

(54) COATED AND LAYERED STRUCTURES TO CREATE LIDAR REFLECTIVE BLACK COMPOSITES

(71) Applicant: Toyota Motor Engineering & Manufacturing North America, Inc., Plano, TX (US)

(72) Inventors: Christopher Anderson, Tukwila, WA (US); Michael P. Rowe, Pinckney, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/889,905

(22) Filed: Sep. 19, 2024

(51) Int. Cl. C09D 5/33; C09D 5/32; C09D 7/40; C09D 7/61

(52) U.S. Cl. CPC C09D 5/004; C09D 5/32; C09D 7/61; C09D 7/67

(57) ABSTRACT

A composite material having a core, and a shell at least partially encompassing the core. At least one of the core and the shell includes copper oxide crystallites. The composite material has a reflectivity in the visible spectrum of electromagnetic radiation that is less than or equal to 10.0%, and a reflectivity in the near-IR and LiDAR spectrum of electromagnetic radiation that is greater than or equal to 12%.

### TECHNICAL FIELD

The present specification generally relates to composite materials that reflect near-IR electromagnetic radiation and, more specifically, to composite materials comprising copper oxide particles that reflect near-IR electromagnetic radiation.

### BACKGROUND

Light detecting and ranging (LiDAR) systems using pulsed laser electromagnetic radiation with a wavelength of 905 nanometers (nm) or 1050 nm have been proposed and tested for autonomous vehicle obstacle detection and avoidance systems as well as in other automated and covert detection systems. However, dark colored (e.g., black) pigments used in paints and other materials to provide a dark-colored objects absorb not only visible electromagnetic radiation to provide the dark color, but also absorb near-IR electromagnetic radiation with wavelengths greater than about 750 nm, which includes LiDAR electromagnetic radiation.

Accordingly, a need exists for alternative dark colored pigments that absorb electromagnetic radiation within the visible spectrum, but that reflect near-IR electromagnetic radiation with wavelengths around 905 nm or 1050 nm.

### SUMMARY

A first aspect includes a composite material comprising: a core, and a shell at least partially encompassing the core, wherein at least one of the core and the shell comprises copper oxide crystallites, and the composite material comprises: a reflectivity in the visible spectrum of electromagnetic radiation that is less than or equal to 10.0%, and a reflectivity in the near-IR and LiDAR spectrum of electromagnetic radiation that is greater than or equal to 12%.
A second aspect includes the composite material of the first aspect, wherein the copper oxide crystallites are present in the core.
A third aspect includes the composite material of any one of the first or second aspects, wherein the copper oxide crystallites are present in the shell.
A fourth aspect includes the composite material of the third aspect, wherein the core comprises a black-colored material.
A fifth aspect includes the composite material of the fourth aspect, wherein the core comprises carbon black.
A sixth aspect includes the composite material of any one of the first to fifth aspects, wherein the copper oxide crystallites have an average particle size that is greater than or equal to 5 nm and less than or equal to 15 nm.
A seventh aspect includes the composite material of any one of the first to sixth aspects, wherein the copper oxide crystallites comprise: a ratio of (−111)/(111) greater than or equal to 0.5 and less than or equal to 1.5; and a blackness My greater than or equal to 130 and less than or equal to 170.
An eighth aspect includes the composite material of any one of the first to seventh aspects, wherein the copper oxide crystallites are infused to at least one of the core and the shell in an amount that is greater than or equal to 0.1% and less than or equal to 22% by mass.
A ninth aspect includes the composite material of any one of the first to eighth aspects, wherein the core comprises a plastic selected from the group consisting of polyethylene terephthalate (PET), acrylonitrile butadiene styrene (ABS), polypropylene, polyethylene, polyvinyl chloride (PVC), polystyrene, and combinations thereof.
A tenth aspect includes the composite material of any one of the first to ninth aspects, wherein the shell comprises a clear coat selected from the group consisting of epoxy, polyurethane, polyacrylic, lacquer, and combinations thereof.
An eleventh aspect includes the composite material of any one of the first to tenth aspects, wherein the shell comprises a plastic selected from the group consisting of polyethylene terephthalate (PET), acrylonitrile butadiene styrene (ABS), polypropylene, polyethylene, polyvinyl chloride (PVC), polystyrene, and combinations thereof.
A twelfth aspect includes the composite material of any one of the first to eleventh aspects, wherein the shell has a thickness that is greater than or equal to 5 nm and less than or equal to 40 μm.
A thirteenth aspect includes the composite material of any one of the first to twelfth aspects, wherein the composite material comprise a blackness M_{y} that is greater than or equal to 125 and less than or equal to 300.
A fourteenth aspect includes a composite material comprising: a core comprising copper oxide crystallites, and a shell at least partially encompassing the core, wherein the shell comprises a colorant, and the composite material comprises a reflectivity in the near-IR and LiDAR spectrum of electromagnetic radiation that is greater than or equal to 12%.
A fifteenth aspect includes the composite material of the fourteenth aspect, wherein the copper oxide crystallites have an average particle size that is greater than or equal to 5 nm and less than or equal to 15 nm.
A sixteenth aspect includes the composite material of any one of the fourteenth or fifteenth aspects, wherein the copper oxide crystallites comprise: a ratio of (−111)/(111) greater than or equal to 0.5 and less than or equal to 1.5; and a blackness My greater than or equal to 130 and less than or equal to 170.
A seventeenth aspect includes the composite material of any one of the fourteenth to sixteenth aspects, wherein the copper oxide crystallites are infused into the core in an amount that is greater than or equal to 0.1% and less than or equal to 22% by mass.
An eighteenth aspect includes the composite material of any one of the fourteenth to seventeenth aspects, wherein the core comprises a plastic selected from the group consisting of polyethylene terephthalate (PET), acrylonitrile butadiene styrene (ABS), polypropylene, polyethylene, polyvinyl chloride (PVC), polystyrene, and combinations thereof.
A nineteenth aspect includes the composite material of any one of the fourteenth to eighteenth aspects, wherein the shell comprises a clear coat selected from the group consisting of epoxy, polyurethane, polyacrylic, lacquer, and combinations thereof.
A twentieth aspect includes the composite material of any one of the fourteenth to nineteenth aspects, wherein the shell comprises a plastic selected from the group consisting of polyethylene terephthalate (PET), acrylonitrile butadiene styrene (ABS), polypropylene, polyethylene, polyvinyl chloride (PVC), polystyrene, and combinations thereof.
A twenty-first aspect includes the composite material of any one of the fourteenth to twentieth aspects, wherein the shell has a thickness that is greater than or equal to 5 nm and less than or equal to 40 μm.

These and additional features provided by the embodiments described herein will be more fully understood in view of the following detailed description in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A graphically depicts the reflectivity versus wavelength of electromagnetic radiation for conventional colorants;

FIG. 1B graphically depicts the reflectivity versus wavelength of electromagnetic radiation for copper oxide crystallites according to embodiments disclosed and described herein;

FIG. 2 is a bar graph depicting the blackness of commercially available materials and black TiO₂;

FIG. 3A depicts the blackness My value of carbon black, commercial “cool black”, commercial N—CuO—C and N—CuO-A pigment, respectively, and the insert photo reveals the blackness difference of these four samples;

FIG. 3B graphically depicts the reflectivity of carbon black, commercial “cool black”, commercial N—CuO—C and N——CuO-A pigment, versus wavelength;

FIG. 3C depicts XRD profiles of N—CuO-A, N—CuO-B and commercial N—CuO—C, where planes of (−111) and (111) are major planes for analysis as they have highest peak intensity;

FIG. 3D depicts an evaluation map of samples using the following 2 indicators: crystallite size of (−111) and relative intensity ratio of (−111)/(111), and the insert shows raw particle samples, from left to right, N—CuO-A, N—CuO-B and commercial N—CuO—C, respectively;

FIG. 4 are Photos of CuO particles with different Cu/Na molar ratios over black background and white background under normal camera (top) and NIR camera (bottom);

FIG. 5 is a cross-sectional schematic of a composite material having copper oxide crystallites in the shell and a black-colored core;

FIG. 6 is a cross-sectional schematic of a composite material having copper oxide crystallites in the core and a tinted shell; and

FIG. 7 is a cross-sectional schematic of a composite material having copper oxide crystallites in the core and a clear shell.

### DETAILED DESCRIPTION

Copper oxide crystallites disclosed and described herein display a dark color and reflect near-IR electromagnetic radiation, which includes LiDAR, with wavelengths greater than or equal to 850 nm and less than or equal to 1550 nm. However, it may be desirable to augment the copper oxide crystallites by incorporating the copper oxide crystallites into composite materials to provide additional optical properties, protect the copper oxide crystallites, improve the integration of the copper oxide crystallites into a material, or the like.

As used herein, the term “near-IR electromagnetic radiation” refers to electromagnetic radiation with wavelengths greater than or equal to 800 nm and less than or equal to 2500 nm, and “LiDAR” refers to electromagnetic radiation with wavelengths greater than or equal to 905 nm and less than or equal to 1550 nm.

As used herein, the term “visible spectrum” refers to electromagnetic radiation with wavelengths greater than or equal to 350 nm and less than or equal to 750 nm.

One difficulty in forming dark-colored (such as black) particles and systems that reflect LiDAR or near-IR electromagnetic radiation is the close proximity of the visible spectrum of electromagnetic radiation and near-IR electromagnetic radiation or LiDAR. Materials that provide a dark color, such as black, do not reflect electromagnetic radiation within the visible spectrum. Such materials will generally also not reflect electromagnetic radiation just outside of the visible spectrum of electromagnetic radiation, such as near-IR and LiDAR electromagnetic radiation. Carbon black is one such material that is commonly used as a dark pigment and that does not reflect electromagnetic radiation in the visible spectrum and that also does not reflect near-IR or LiDAR electromagnetic radiation. Accordingly, a material that does not reflect electromagnetic radiation within the visible spectrum but that does reflect near-IR or LiDAR electromagnetic radiation is required to have a very sharp increase in reflectivity just outside of the visible spectrum of electromagnetic radiation.

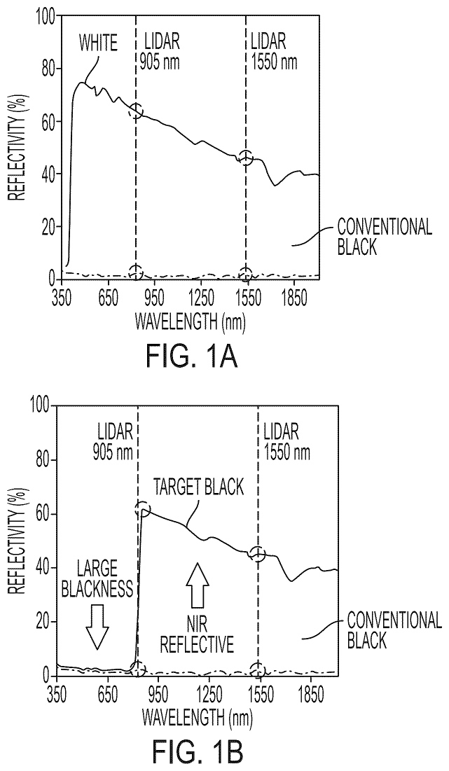

With reference now to FIG. 1A, the reflectivity of materials that are commonly used as colorants are shown. The percentage of reflectivity is presented along the y-axis of FIG. 1A and the wavelength of the electromagnetic radiation is provided along the x-axis of FIG. 1A. The reflectivity of a conventional black colorant, such as carbon black, is shown along the bottom of the graph. As shown in FIG. 1A, the carbon black colorant does not reflect electromagnetic radiation in the visible spectrum (to the left of the graph). Namely, the reflection of this black colorant is near zero percent within the visible spectrum of electromagnetic radiation. This indicates that the colorant provides a dark, nearly pure black color. However, this conventional colorant also reflects around zero percent of electromagnetic radiation outside of the visible spectrum (to the right on the graph), such as near-IR electromagnetic radiation or LiDAR electromagnetic radiation (e.g., from greater than about 750 nm to about 1550 nm). Similarly, near the top of the graph is shown the reflectivity of white TiO₂, which is used as a conventional white colorant. As shown in FIG. 1A, white TiO₂ reflects near-IR and LiDAR electromagnetic radiation as shown on the right side of the graph (e.g., from greater than about 750 nm to 1550 nm) where the reflection of near-IR and LiDAR electromagnetic radiation is greater than forty percent (at 1550 nm), and around sixty percent (at 905 nm). However, white TiO₂, as the name indicates, also reflects electromagnetic radiation within the visible spectrum. As shown in FIG. 1A, white TiO₂ reflects nearly eighty percent of electromagnetic radiation within the visible spectrum. Accordingly, neither of these colorants—carbon black or white TiO₂—are suitable as a dark-colored particle that also reflects near-IR or LiDAR electromagnetic radiation.

FIG. 1B is a graph showing the target conditions of a particle that does not reflect light in the visible spectrum of electromagnetic radiation, but that does reflect near-IR and LiDAR electromagnetic radiation. In FIG. 1B, the percentage of reflectivity is measured along the y-axis and the wavelength of electromagnetic radiation is provided along the x-axis. Along the bottom of the graph is shown the reflectivity of a conventional black colorant, which is identical to the reflectivity of the conventional black colorant (such as carbon black) shown in FIG. 1A. As shown in FIG. 1B, particles that do not reflect electromagnetic within the visible spectrum and that reflect near-IR and LiDAR electromagnetic radiation have at least two distinct regions of reflection. The first region of reflection is within the visible spectrum of electromagnetic radiation, indicated on the left side of the graph in FIG. 1B. In this region of reflection, particles that do not reflect electromagnetic within the visible spectrum and that reflect near-IR and LiDAR electromagnetic radiation will behave the same as conventional black colorants (such as carbon black) by not reflecting electromagnetic radiation within the visible spectrum. As shown in FIG. 1B, particles that do not reflect electromagnetic within the visible spectrum and that reflect near-IR and LiDAR electromagnetic radiation reflect nearly zero percent of electromagnetic radiation within the visible spectrum. However, particles that do not reflect electromagnetic within the visible spectrum and that reflect near-IR and LiDAR electromagnetic radiation have a second region of reflection that is outside of the visible spectrum of electromagnetic radiation.

The second region of reflection encompasses electromagnetic radiation with wavelengths greater than or equal to 750 nm and less than or equal to 1050 nm (which includes near-IR and LiDAR electromagnetic radiation). In the second region of reflection, the particles that do not reflect electromagnetic within the visible spectrum and that reflect near-IR and LiDAR electromagnetic radiation perform similarly as white TiO₂ by reflecting a high amount of electromagnetic radiation within the second region of reflection. As shown in FIG. 1B, particles that do not reflect electromagnetic within the visible spectrum and that reflect near-IR and LiDAR electromagnetic radiation reflect, for example, about sixty percent of LiDAR electromagnetic radiation having a wavelength of 905 nm and reflects greater than forty percent of LiDAR electromagnetic radiation having a wavelength of 1550 nm. By having reflectance in the second region of reflection that is similar to white TiO₂, particles can reflect a sufficient amount of near-IR and LiDAR electromagnetic radiation that the particles can be detected by LiDAR systems.

FIG. 1B shows the difficulty in forming particles that do not reflect electromagnetic within the visible spectrum and that reflect near-IR and LiDAR electromagnetic radiation. Particularly, FIG. 1B shows a steep increase in reflectance just outside of the visible spectrum of electromagnetic radiation. In embodiments, this steep increase of reflectance is present at a wavelength of electromagnetic radiation that is at or about 905 nm, which is a wavelength of electromagnetic radiation commonly used in LiDAR systems. As shown in FIG. 1B, the reflectance increases from about zero percent to nearly sixty percent at a wavelength of electromagnetic radiation that is about 905 nm. Forming a particle with such a precise and steep increase in reflectance is difficult to achieve and there is very little room for error. For instance, if the material reflects too much electromagnetic radiation within the visible spectrum, the appearance of the color will not be pure black, but will have hints of, for example, red or purple. However, if the material does not reflect a sufficient amount of near-IR or LiDAR electromagnetic radiation, the material will not be suitable for detection by LiDAR systems.

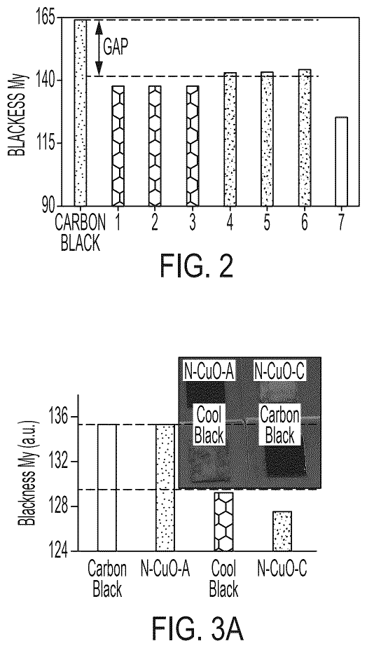

Some materials do not reflect electromagnetic radiation within much of the visible spectrum and reflect near-IR and LiDAR electromagnetic radiation; however, these materials have not been able to reproduce the visible appearance of carbon black (i.e., has a reflectivity of about zero percent for electromagnetic radiation within the visible spectrum). One such material that has gained interest is chromium iron oxide and derivatives thereof. Although chromium iron oxide materials can generally reflect near-IR and LiDAR electromagnetic radiation, colorants made from chromium iron oxide materials are generally referred to as “cool black” because colorants made from chromium iron oxide or derivatives thereof have hints of red or blue in them. FIG. 2 is a bar graph that shows the blackness of various materials on the y-axis. Blackness is measured by X-Rite Spectrophotometer. At the far left of FIG. 2 is carbon black, which is the material commonly used as a black colorant, but carbon black does not reflect near-IR or LiDAR electromagnetic radiation. As shown in FIG. 2, carbon black has a blackness of about 165. Materials 1-7 are chromium iron oxide containing materials that reflect near-IR and LiDAR electromagnetic radiation, but as can be seen in FIG. 2, these materials have a blackness that is around 142 or less. This difference in blackness is notable, as materials 1-7 have tints of red or blue. Thus, this considerable gap in blackness between carbon black and materials 1-7 show that materials 1-7 are generally not suitable to be used in applications where pure black is desired, such as, for example, in paint, textiles, and the like. Consequently, there is a need for a durable and inexpensive pigment that has a blackness similar to carbon black, such as pigment from Cabot Corporation (denoted as “Carbon Black”), and that also reflects near-IR and LiDAR electromagnetic radiation.

### Copper Oxide Crystallites

Without being bound by any particular theory, it is believed that the sharp transition of reflectivity (or absorbance) between 700 nm wavelength and 905 nm wavelength electromagnetic radiation is attributed to the near unity ratio of (−111)/(111) crystal facets and at a crystal size around 100 Å for the (−111) plane.

One material of interest for black color applications is copper (II) oxide or cupric oxide (CuO). CuO is a common inorganic compound that is a black-colored solid material in its natural state. However, not all copper oxides have this black color. Namely, another stable oxide of copper is cuprous oxide (Cu₂O) that is a red solid in its natural state. Therefore, the oxidation state of copper is important to ensure that the material has a black color. CuO is a product of copper mining and it is a precursor to many other copper-containing products and chemical compounds. CuO has been used as a black pigment in certain applications, such as in ceramics, glazes, and the like. However, commonly used CuO does not reflect near-IR or LiDAR electromagnetic radiation. That is, CuO in its natural state behaves much like carbon black in that it does not reflect electromagnetic radiation in the visible spectrum and it also does not reflect electromagnetic radiation in the near-IR or LiDAR spectrum. Without being bound to any particular theory, CuO has a band gap of 2.0 eV that, as described in more detail below, does not readily reflect electromagnetic radiation in the near-IR or LiDAR spectrum. When manipulating CuO to have a band gap that is more amenable to reflecting electromagnetic radiation in the near-IR or LiDAR spectrum, the color of the CuO degrades to a brownish black, which is not suitable for certain applications, such as in paint, textiles, and the like.

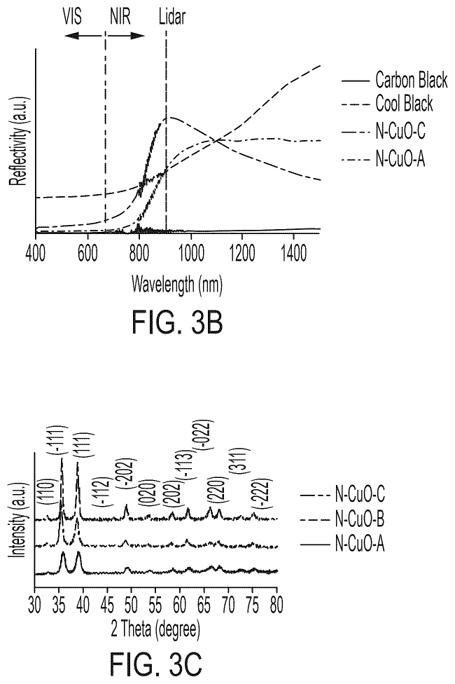

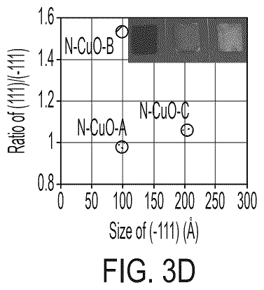

Carbon black exhibits very low reflection (less than 1%) throughout the visible and near-IR wavelength resulting in high blackness My value around 135. Commercial CuO have higher near-IR reflectivity selectively of wavelengths of electromagnetic radiation wavelengths from 900 nm to 1000 nm, but commercial CuO shows distinguishable reflection in visible wavelength particularly in red hue, resulting in obvious brownish tone appearance with blackness My value less than 130. On the other hand, “cool black” shows strong reflection in the deeper end of the near-IR spectra at electromagnetic radiation wavelengths greater than 905 nm yet does not sufficiently absorb in the visible wavelengths with blackness My value of 128. Insert photo in FIG. 3A shows the difference in blackness of these raw pigment samples, shows the practical application of the reflectance spectra in visible range, as shown in FIG. 3B. In the figures, N—CuO—C is commercial CuO and N—CuO-A is CuO according to embodiments disclosed and described herein. One way of determining this transition of low reflectivity in the visible spectrum of electromagnetic radiation to high reflectivity at near-IR and LiDAR electromagnetic radiation is by evaluating the band gap of a material.

The band gap generally refers to the energy difference (in electron volts or eV) between the top of the valence band (VB) and the bottom of the conduction band (CB). The VB is the band of electron orbitals that electrons can jump out of, moving into the CB when excited. The VB is the outermost electron orbital of an atom that electrons can actually occupy. The band gap is the energy required for an electron to move from the VB to the CB and can be indicative of the electrical conductivity of the material. In optics, the band gap correlates to the threshold where photons can be absorbed by a material. Therefore, without begin bound by any particular theory, the band gap determines what portion of the electromagnetic spectrum the material can absorb. Generally, a material with a large band gap will absorb a greater portion of electromagnetic spectra having a short wavelength, and a material with a small band gap will absorb a greater portion of electromagnetic spectra having long wavelengths. Put differently, a large band gap means that a lot of energy is required to excite valence electrons to the CB. In contrast, when the valence band and conduction band overlap as they do in metals, electrons can readily jump between the two bands, which means that the material is highly conductive. However, it has been found that by manipulating the band gap of a material, the types of electromagnetic spectra that are absorbed by the material may be controlled. In view of this, materials with bandgap energy near the LiDAR detection electromagnetic radiation wavelength (around 905 nm) have a band gap around 1.37 eV and sharp transition at the visible edge (around 700 nm) and are promising candidates as materials that do not reflect visible electromagnetic radiation but that do reflect near-IR and LiDAR electromagnetic radiation.

Cupric (II) oxide (CuO) is a monoclinic p-type semiconductor with fundamental bandgap of indirect nature. The experimental values of its indirect bandgap have been determined to be in the range of 1.2 eV to 2.2 eV. CuO compounds have been studied widely in areas such as solar energy materials, gas sensors, magnetic media, optical devices, batteries, catalyst, as well as constructing junction devices and superconducting materials. It has also been emphasized that the bandgap of CuO is tunable by means of different approaches such as dopants, synthesis solvent and stoichiometry, nanoparticle size, and the shape of the nanostructure as well as the morphology. Currently, the bandgap engineering studies of CuO focus on an optical response to solar radiation and its catalytic behavior. However, there is no disclosure directed to tailoring CuO to absorb wavelengths in the visible spectrum of electromagnetic radiation and to reflect electromagnetic radiation wavelengths in near-IR and LiDAR spectrum. There have been past efforts to improve the blackness of CuO by physically tailoring the particle size via ball milling or other techniques. However, it has not been possible to mill CuO to reach the blackness level of carbon black.

Generally, a band gap of from 1.2 eV to 1.8 eV is required for a compound to absorb (i.e., not reflect) electromagnetic radiation in the visible spectrum and reflect electromagnetic radiation in the near-IR and LiDAR spectrum. Without manipulation, bulk CuO does not meet these requirements. Bulk CuO has a reported band gap of 2.0 eV and a blackness My value of 128. This band gap is outside of the 1.2 eV to 1.8 eV required to reflect electromagnetic radiation in the near-IR and LiDAR spectrum. Further, as noted above with reference to FIG. 2, a blackness of 128 is significantly lower than the blackness of about 165 for carbon black. Accordingly, in embodiments disclosed and described herein, methods for forming CuO crystallites having significantly reduced particle sizes that result in a decrease the bandgap and increase in the blackness of CuO are provided.

In embodiments, a synthesis of a type of CuO crystallites (also referred to herein as “N—CuO-A”) that may be used as a replacement for carbon black and show superior blackness in the visible spectrum of electromagnetic radiation while also having high reflectivity in near-IR and LiDAR electromagnetic radiation wavelengths are provided. The N—CuO-A may, in embodiments be synthesized via scalable precipitation-pyrolysis method—with proper selection in precipitating agents at certain concentration ranges—that is followed by a well-defined sintering process. Structural and chemical composition studies depict the evolution from precursor to extracted precipitates, and to final CuO crystallites at various process stages. As referenced above, two key indicators in XRD spectra to guide the experimental conditions towards the desired crystal structure and resultant optical contrast in both visible and near-IR range were unexpectedly discovered.

A comparison of different CuO particles obtained from the precursor Cu(NO₃)₂ with different alkaline bases generally used to synthesize CuO, namely, a weak base Na₂CO₃ for N—CuO-A and a strong base NaOH for the other CuO particles (referred to herein as “N—CuO-B”) provides understanding of the origin of significantly higher blackness and near-IR or LiDAR reflection in certain CuO crystallites. N—CuO-A and N—CuO-B are prepared following the same sintering conditions in a conventional oven (300° C. for 3 hours) to provide the comparison. Commercial nanostructured CuO (referred to herein as “N—CuO—C”) is a reference for comparison to N—CuO-A and N—CuO-B. FIG. 3C shows XRD profiles of these CuO samples. It reveals that all the samples are pure cupric (II) oxide with a monoclinic structure, and approximately corresponding with JCPDS No. 03-065-2309. The diffraction peaks at 2θ values of 33.5°, 35.5°, 38.2°, 48.7°, 54.2°, 58.3°, 62.5°, 66.4°, 68.2°, 73.4°, and 75.6°are observed for all of the samples, which correspond respectively to the lattice planes of (110), (−111), (111), (−112), (−202), (020), (202), (−113), (220), (311), and (−222) . Among those planes, the intensity of (−111) and (111) peaks is much stronger than that of other peaks, which indicates this orientation of the formed nanocrystals along these directions provides the type of reflectivity desired according to embodiments. No peaks of impurity phases such as Cu₂O are detected. The relatively broad XRD peaks in N—CuO-A and N—CuO-B indicate that the size of crystals in both N—CuO-A and N—CuO-B are both relatively small (about 100 Å) under provided sintering conditions. Comparatively, the XRD profile of N—CuO—C shows much narrower and sharper peaks, indicating larger crystallite sizes (about 204 Å). Though N—CuO-A and N—CuO-B have similar crystallite size, a close look on the XRD spectra reveals that the relative intensity ratio between the two major lattice planes (−111) and (111) in N—CuO-A and N—CuO-B are significantly different.

As seen from FIG. 3C, N—CuO-A does show relatively smaller ratio of (−111)/(111) than N—CuO-B. According to the calculated potential of the low-index surfaces of CuO using DFT method, (111) plane has a valence band maximum edge (VBM) near 1.2 eV (or about 1030 nm) with a bandgap energy of 1.5 eV, while (−111) plane has a slightly larger VBM around 2.1 eV (or about 620 nm) with a slightly larger bandgap energy of 1.6 eV. Accordingly, visual observation indicates that (−111) plane is the major cause for visible reflection as it starts from a larger VBM around 620 nm. Therefore, smaller ratio of (−111)/(111) or smaller crystallite size of (−111) plane would potentially lead to higher blackness level, while larger ratio and crystallite size would benefit near-IR or LiDAR reflectivity.

As seen in FIG. 3D, N—CuO-A has lowest ratio and smallest crystallite size, and it has highest level of blackness but relatively weaker near-IR reflectivity (left sample in the insert for FIG. 3D). Samples that have either larger crystallite size (e.g., N—CuO—C) (right sample in the insert of FIG. 3D) or a relatively higher ratio of (−111)/(111) (e.g., N—CuO-B) show brownish color (middle sample in the insert of FIG. 3D). The near-IR reflections in these two samples are higher due to the dominant (−111) plane (N—CuO-B) or the larger average crystallite size of (−111) plane (N—CuO—C). Therefore, without being bound by any particular theory, it is believed that these are two key indicators for materials that will absorb electromagnetic radiation in the visible spectrum and reflect electromagnetic radiation in the near-IR and LiDAR spectrums; the ratio of (−111)/(111) planes in the crystallite phases and the average crystallite size of the resultant CuO crystallites. According to embodiments, maintaining a balance of the ratio (−111)/(111) around one and the crystallite size of (−111) around 100 Å help achieve LiDAR reflectivity and visual blackness. Further discussion of these attributes is provided in U.S. Patent Application Publication No. 2022/0017379 published on Jan. 20, 2022, which is incorporated herein by reference in its entirety.

Accordingly, in embodiments, the ratio of (−111)/(111) may be greater than or equal to 0.8 and less than or equal to 1.3, such as greater than or equal to 0.9 and less than or equal to 1.3, greater than or equal to 1.0 and less than or equal to 1.3, greater than or equal to 1.1 and less than or equal to 1.3, greater than or equal to 1.2 and less than or equal to 1.3, greater than or equal to 0.8 and less than or equal to 1.2, greater than or equal to 0.9 and less than or equal to 1.2, greater than or equal to 1.0 and less than or equal to 1.2, greater than or equal to 1.1 and less than or equal to 1.2, greater than or equal to 0.8 and less than or equal to 1.1, greater than or equal to 0.9 and less than or equal to 1.1, greater than or equal to 1.0 and less than or equal to 1.1, greater than or equal to 0.8 and less than or equal to 1.0, greater than or equal to 0.9 and less than or equal to 1.0, or greater than or equal to 0.8 and less than or equal to 0.9.

By reducing the size of CuO particles, such as to the average particle sizes disclosed below, the band gap of the CuO decreases. In embodiments, the band gap as measured by X-ray photoelectron spectroscopy (XPS) of the CuO crystallites is greater than or equal to 1.2 eV and less than or equal to 1.8 eV, such as greater than or equal to 1.3 eV and less than or equal to 1.8 eV, greater than or equal to 1.4 eV and less than or equal to 1.8 eV, greater than or equal to 1.5 eV and less than or equal to 1.8 eV, greater than or equal to 1.6 eV and less than or equal to 1.8 eV, greater than or equal to 1.7 eV and less than or equal to 1.8 eV, is greater than or equal to 1.2 eV and less than or equal to 1.7 eV, such as greater than or equal to 1.3 eV and less than or equal to 1.7 eV, greater than or equal to 1.4 eV and less than or equal to 1.7 eV, greater than or equal to 1.5 eV and less than or equal to 1.7 eV, greater than or equal to 1.6 eV and less than or equal to 1.7 eV, greater than or equal to 1.2 eV and less than or equal to 1.6 eV, such as greater than or equal to 1.3 eV and less than or equal to 1.6 eV, greater than or equal to 1.4 eV and less than or equal to 1.6 eV, greater than or equal to 1.5 eV and less than or equal to 1.6 eV, greater than or equal to 1.2 eV and less than or equal to 1.5 eV, such as greater than or equal to 1.3 eV and less than or equal to 1.5 eV, greater than or equal to 1.4 eV and less than or equal to 1.5 eV, greater than or equal to 1.2 eV and less than or equal to 1.4 eV, such as greater than or equal to 1.3 eV and less than or equal to 1.4 eV, or greater than or equal to 1.2 eV and less than or equal to 1.3 eV.

Without being bound by any particular theory, it is believed that the smaller the average crystal size of the CuO crystallites, the lower the band gap of the CuO crystallites will be. Thus, by reducing bulk CuO particles to CuO crystallites according to embodiments disclosed and described herein, the band gap of the CuO crystallites is within the range that will reflect electromagnetic radiation within the near-IR and LiDAR spectrum, such as having a band gap that is between 1.5 eV and 2.0 eV.

In embodiments, the CuO crystallites may have an average particle size that is greater than or equal to 5 nm and less than or equal to 15 nm, such as greater than or equal to 6 nm and less than or equal to 14 nm, greater than or equal to 9 nm and less than or equal to 13 nm, greater than or equal to 10 nm and less than or equal to 12 nm, greater than or equal to 5 nm and less than or equal to 10 nm, greater than or equal to 6 nm and less than or equal to 10 nm, greater than or equal to 7 nm and less than or equal to 10 nm, greater than or equal to 8 nm and less than or equal to 10 nm, or greater than or equal to 5 nm and less than or equal to 8 nm.

The blackness My (i.e., a measure of blackness) of the CuO crystallites is, in embodiments, greater than or equal to 130 and less than or equal to 170, such as greater than or equal to 135 and less than or equal to 170, greater than or equal to 140 and less than or equal to 170, greater than or equal to 145 and less than or equal to 170, greater than or equal to 150 and less than or equal to 170, greater than or equal to 155 and less than or equal to 170, greater than or equal to 160 and less than or equal to 170, greater than or equal to 165 and less than or equal to 170, greater than or equal to 130 and less than or equal to 165, greater than or equal to 135 and less than or equal to 165, greater than or equal to 140 and less than or equal to 165, greater than or equal to 145 and less than or equal to 165, greater than or equal to 150 and less than or equal to 165, greater than or equal to 155 and less than or equal to 165, greater than or equal to 160 and less than or equal to 165, greater than or equal to 130 and less than or equal to 160, greater than or equal to 135 and less than or equal to 160, greater than or equal to 140 and less than or equal to 160, greater than or equal to 145 and less than or equal to 160, greater than or equal to 150 and less than or equal to 160, greater than or equal to 155 and less than or equal to 160, greater than or equal to 130 and less than or equal to 155, greater than or equal to 135 and less than or equal to 155, greater than or equal to 140 and less than or equal to 155, greater than or equal to 145 and less than or equal to 155, greater than or equal to 150 and less than or equal to 155, greater than or equal to 130 and less than or equal to 150, greater than or equal to 135 and less than or equal to 150, greater than or equal to 140 and less than or equal to 150, greater than or equal to 145 and less than or equal to 150, greater than or equal to 130 and less than or equal to 145, greater than or equal to 135 and less than or equal to 145, greater than or equal to 140 and less than or equal to 145, greater than or equal to 130 and less than or equal to 140, greater than or equal to 135 and less than or equal to 140, or greater than or equal to 130 and less than or equal to 135.

Copper oxide crystallites according to embodiments disclosed and described herein have a reflectivity in the visible spectrum of electromagnetic radiation that is less than or equal to 10.0%, such as less than or equal to 9.0%, less than or equal to 8.0%, less than or equal to 7.0%, less than or equal to 6.0%, less than or equal to 5.0%, less than or equal to 4.0%, less than or equal to 3.0%, less than or equal to 2.0%, less than or equal to 1.0%, or less than or equal to 0.5%.

Copper oxide crystallites according to embodiments disclosed and described herein have a reflectivity in the near-IR and LiDAR spectrum of electromagnetic radiation that is greater than or equal to 10%, such as greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, or greater than or equal to 60%. In one or more embodiments, the copper oxide crystallites have a reflectivity in the near-IR and LiDAR spectrum of electromagnetic radiation that is greater than or equal to 10% and less than or equal to 60%, such as greater than or equal to 15% and less than or equal to 60%, greater than or equal to 20% and less than or equal to 60%, greater than or equal to 25% and less than or equal to 60%, greater than or equal to 30% and less than or equal to 60%, greater than or equal to 35% and less than or equal to 60%, greater than or equal to 40% and less than or equal to 60%, greater than or equal to 45% and less than or equal to 60%, greater than or equal to 50% and less than or equal to 60%, greater than or equal to 55% and less than or equal to 60%, greater than or equal to 15% and less than or equal to 55%, greater than or equal to 20% and less than or equal to 50%, greater than or equal to 25% and less than or equal to 45%, or greater than or equal to 30% and less than or equal to 40%.

Methods for making CuO crystallites according to embodiments are described in U.S. Patent Application Publication No. 2022/0396495 published on Dec. 15, 2022, which is incorporated by reference herein in its entirety.

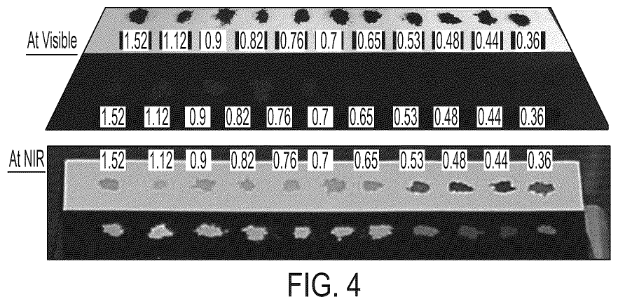

In one or more embodiments, the copper oxide crystallites may be made using a precursor comprising sodium (such as sodium hydroxide or sodium carbonate). In such embodiments, it the copper to sodium (Cu/Na) ratio may have an effect on the blackness of the copper oxide crystallites. For instance, FIG. 4 shows photographic image of the CuO crystallites with varying Cu/Na molar ratios over black and white backgrounds in the same order. As shown on the black background, the visual blackness of powders increases with decreasing Cu/Na molar ratio until about 0.7, and then ineligible change in the blackness is observed with further decrease in the Cu/Na molar ratio. However, the photo taken using near-IR camera indicates near-IR and LiDAR reflectivity greatly reduces if Cu/Na molar ratio reduces to less than 0.65, which implies the adverse effect of the Na⁺ impurity onto the crystal structures and the near-IR and LiDAR reflectivity.

Accordingly, in embodiments, the Cu/Na molar ratio used in precipitates to formulate CuO crystallites, is greater than or equal to 0.3 and less than 1.6, such as greater than or equal to 0.4 and less than 1.6, greater than or equal to 0.5 and less than 1.6, greater than or equal to 0.6 and less than 1.6, greater than or equal to 0.7 and less than 1.6, greater than or equal to 0.8 and less than 1.6, greater than or equal to 0.9 and less than 1.6, greater than or equal to 1.0 and less than 1.6, greater than or equal to 1.1 and less than 1.6, greater than or equal to 1.2 and less than 1.6, greater than or equal to 1.3 and less than 1.6, greater than or equal to 1.4 and less than 1.6, greater than or equal to 1.5 and less than 1.6, greater than or equal to 0.3 and less than or equal to 1.5, greater than or equal to 0.3 and less than or equal to 1.4, greater than or equal to 0.3 and less than or equal to 1.3, greater than or equal to 0.3 and less than or equal to 1.2, greater than or equal to 0.3 and less than or equal to 1.1, greater than or equal to 0.3 and less than or equal to 1.0, greater than or equal to 0.3 and less than or equal to 0.9, greater than or equal to 0.3 and less than or equal to 0.8, greater than or equal to 0.3 and less than or equal to 0.7, greater than or equal to 0.3 and less than or equal to 0.6, greater than or equal to 0.3 and less than or equal to 0.5, or greater than or equal to 0.3 and less than or equal to 0.4.

In some embodiments, ammonium carbonate ((NH₄)₂CO₃) is used as a precursor to form the CuO crystallites. In such embodiments, the ratio of carbonate to copper (CO₃/Cu) may affect the blackness of the copper oxide crystallites. Accordingly, the CO₃/Cu molar ratio is greater than or equal to 0.3 and less than 1.6, such as greater than or equal to 0.4 and less than 1.6, greater than or equal to 0.5 and less than 1.6, greater than or equal to 0.6 and less than 1.6, greater than or equal to 0.7 and less than 1.6, greater than or equal to 0.8 and less than 1.6, greater than or equal to 0.9 and less than 1.6, greater than or equal to 1.0 and less than 1.6, greater than or equal to 1.1 and less than 1.6, greater than or equal to 1.2 and less than 1.6, greater than or equal to 1.3 and less than 1.6, greater than or equal to 1.4 and less than 1.6, greater than or equal to 1.5 and less than 1.6, greater than or equal to 0.3 and less than or equal to 1.5, greater than or equal to 0.3 and less than or equal to 1.4, greater than or equal to 0.3 and less than or equal to 1.3, greater than or equal to 0.3 and less than or equal to 1.2, greater than or equal to 0.3 and less than or equal to 1.1, greater than or equal to 0.3 and less than or equal to 1.0, greater than or equal to 0.3 and less than or equal to 0.9, greater than or equal to 0.3 and less than or equal to 0.8, greater than or equal to 0.3 and less than or equal to 0.7, greater than or equal to 0.3 and less than or equal to 0.6, greater than or equal to 0.3 and less than or equal to 0.5, or greater than or equal to 0.3 and less than or equal to 0.4.

In embodiments, and as discussed in more detail below, the copper oxide crystallites may be incorporated into a core-shell structure where one or more of the core and shell comprises the copper oxide crystallites. In one or more embodiments, the shell may have a thickness that is greater than or equal to 5 nm to less than or equal to 40 μm, such as greater than or equal to 5 nm and less than or equal to 20 μm, greater than or equal to 5 nm and less than or equal to 10 μm, greater than or equal to 5 nm and less than or equal to 1 μm, greater than or equal to 5 nm and less than or equal to 500 nm, greater than or equal to 5 nm and less than or equal to 200 nm, greater than or equal to 5 nm and less than or equal to 100 nm, greater than or equal to 5 nm and less than or equal to 50 nm, greater than or equal to 50 nm to less than or equal to 40 μm, greater than or equal to 50 nm and less than or equal to 20 μm, greater than or equal to 50 nm and less than or equal to 10 μm, greater than or equal to 50 nm and less than or equal to 1 μm, greater than or equal to 50 nm and less than or equal to 500 nm, greater than or equal to 50 nm and less than or equal to 200 nm, greater than or equal to 200 nm to less than or equal to 40 μm, greater than or equal to 200 nm and less than or equal to 20 μm, greater than or equal to 200 nm and less than or equal to 10 μm, greater than or equal to 200 nm and less than or equal to 1 μm, greater than or equal to 200 nm and less than or equal to 500 nm, greater than or equal to 500 nm to less than or equal to 40 μm, greater than or equal to 500 nm and less than or equal to 20 μm, greater than or equal to 500 nm and less than or equal to 10 μm, greater than or equal to 500 nm and less than or equal to 1 μm, greater than or equal to 1 μm to less than or equal to 40 μm, greater than or equal to 1 μm and less than or equal to 20 μm, greater than or equal to 1 μm and less than or equal to 10 μm, greater than or equal to 1 μm and less than or equal to 5 μm, greater than or equal to 5 μm to less than or equal to 40 μm, greater than or equal to 5 μm and less than or equal to 20 μm, greater than or equal to 5 μm and less than or equal to 10 μm, greater than or equal to 10 μm to less than or equal to 40 μm, greater than or equal to 10 μm and less than or equal to 20 μm, or greater than or equal to 20 μm to less than or equal to 40 μm.

### Composite Materials

According to embodiments, copper oxide crystallites disclosed and described herein above may be incorporated into composite materials. The composite materials of embodiments may comprise a core-shell structure where the copper oxide crystallites are incorporated into one of the core or the shell of the composite material. It should be understood that in embodiments, the core-shell structure may have any geometry, such as spherical, ovoid, cylindrical, conical, prismatic (such as cubic or rectangular), monolith, fibrous, or any abstract shape. The core-shell structure may have an average particle size range of from 0.3 micrometer (μm) to 50 μm.

As used herein, the term “particle size” refers to a value of at least one dimension of a particle, or when referring to a sample of more than one particle, an average value for the at least one dimension over the sample population of particles. Particle size is measured by scanning electron microscopy and transition electron microscopy.

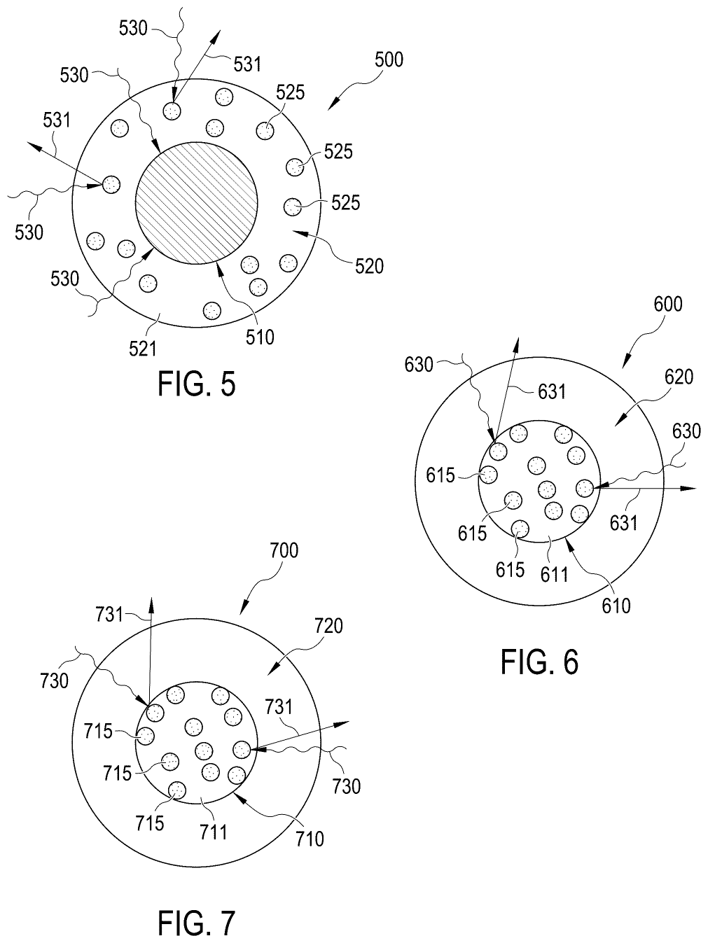

With reference now to FIG. 5, a composite material 500 according to one or more embodiments comprises a core 510 made from a black material and a shell 520 infused with the copper oxide crystallites 525 according to embodiment disclosed and described herein. Although FIG. 5 shows a cross section of a spherical composite material 500, the geometry of composite material according to embodiments should not be so limited and composite materials 500 according to embodiments disclosed and described herein may have any geometry.

The shell 520 may comprise a clear carrier material 521 infused with the copper oxide crystallites 525. In embodiments, the clear carrier material 521 may be any clear coat material, such as epoxy, polyurethane, polyacrylic, lacquer, and combinations thereof. In embodiments, the clear carrier material 521 may be a plastic, such as polyethylene terephthalate (PET), acrylonitrile butadiene styrene (ABS), polypropylene, polyethylene, polyvinyl chloride (PVC), polystyrene, combinations thereof and the like.

The black material comprising the core 510 is, in embodiments, selected from carbon black, black titanium dioxide, chromium oxide, or the like. The black core 510 may absorb electromagnetic radiation in the visible spectrum and absorb electromagnetic radiation in the near-IR and LiDAR spectrums.

Broad-spectrum electromagnetic radiation 530, which includes visible, near-IR, and LiDAR electromagnetic radiation, is incident to the composite material 500. A portion of the broad-spectrum electromagnetic radiation 530 is incident to the copper oxide crystallites 525 where electromagnetic radiation in the visible spectrum is absorbed by the copper oxide crystallites 525 while near-IR and LiDAR electromagnetic radiation 531 is reflected by the copper oxide crystallites 525. However, a portion of the broad-spectrum electromagnetic radiation 530 that is incident to the composite material 500 is not incident to the copper oxide crystallites 525 and may pass through the transparent shell 520 to the core 510 of the composite material, where visible electromagnetic radiation, near-IR electromagnetic radiation, and LiDAR electromagnetic radiation are all absorbed. The composite material of the embodiments depicted in FIG. 5 has a dark black color as nearly all the electromagnetic radiation in the visible spectrum is absorbed by either the core 510 or the copper oxide crystallites 525. The composite material 500 of embodiments depicted in FIG. 5 can use less copper oxide crystallites to achieve a high level of blackness than if only copper oxide crystallites were used and still have significant reflectance of near-IR or LiDAR electromagnetic radiation. This can reduce the cost of producing a near-IR or LiDAR reflective black material when compared to using copper oxide crystallites alone, and can produce a composite material that has better blackness than copper oxide crystallites used alone.

In embodiments, the shell 520 may be infused with greater than or equal to 0.10 mass % copper oxide crystallites based on the total weight of the shell or infused with greater than or equal to 0.1 mass % and less than or equal to 22 mass % of the copper oxide crystallites based on the total weight of the shell, such as greater than or equal to 0.1 mass % and less than or equal to 5 mass % of the copper oxide crystallites, greater than or equal to 0.5 mass % and less than or equal to 5.5 mass % of the copper oxide crystallites, greater than or equal to 1.5 mass % and less than or equal to 6 mass % of the copper oxide crystallites, greater than or equal to 2.0 mass % and less than or equal to 6.5 mass % of the copper oxide crystallites, greater than or equal to 3 mass % and less than or equal to 7 mass % of the copper oxide crystallites, greater than or equal to 4 mass % and less than or equal to 7.5 mass % of the copper oxide crystallites, greater than or equal to 1.5 mass % and less than or equal to 4.5 mass % of the copper oxide crystallites, greater than or equal to 2.0 mass % and less than or equal to 5 mass % of the copper oxide crystallites, greater than or equal to 3.0 mass % and less than or equal to 5.5 mass % of the copper oxide crystallites, greater than or equal to 2 mass % and less than or equal to 4 mass % of the copper oxide crystallites, greater than or equal to 2.5 mass % and less than or equal to 4.5 mass % of the copper oxide crystallites, greater than or equal to 1 mass % and less than or equal to 18 mass % of the copper oxide crystallites, greater than or equal to 1 mass % and less than or equal to 12 mass % of the copper oxide crystallites, greater than or equal to 1 mass % and less than or equal to 5 mass % of the copper oxide crystallites, greater than or equal to 5 mass % and less than or equal to 20 mass % of the copper oxide crystallites, greater than or equal to 5 mass % and less than or equal to 12 mass % of the copper oxide crystallites, greater than or equal to 10 mass % and less than or equal to 22 mass % of the copper oxide crystallites, greater than or equal to 10 mass % and less than or equal to 18 mass % of the copper oxide crystallites, greater than or equal to 15 mass % and less than or equal to 22 mass % of the copper oxide crystallites, or greater than or equal to 18 mass % and less than or equal to 22 mass % of the copper oxide crystallites.

In one or more embodiments, the shell 520 may have a thickness that is greater than or equal to 20 nm and less than or equal to 10 μm, such as greater than or equal to 20 nm and less than or equal to 5 μm, greater than or equal to 20 nm and less than or equal to 1 μm, greater than or equal to 20 nm and less than or equal to 500 nm, greater than or equal to 20 nm and less than or equal to 300 nm, greater than or equal to 20 nm and less than or equal to 150 nm, greater than or equal to 75 nm and less than or equal to 10 μm, greater than or equal to 75 nm and less than or equal to 5 μm, greater than or equal to 75 nm and less than or equal to 1 μm, greater than or equal to 75 nm and less than or equal to 500 nm, greater than or equal to 75 nm and less than or equal to 300 nm, greater than or equal to 75 nm and less than or equal to 150 nm, greater than or equal to 100 nm and less than or equal to 500 nm, greater than or equal to 100 nm and less than or equal to 300 nm, greater than or equal to 300 nm and less than or equal to 10 μm, greater than or equal to 300 nm and less than or equal to 5 μm, greater than or equal to 300 nm and less than or equal to 1 μm, greater than or equal to 300 nm and less than or equal to 500 nm, greater than or equal to 500 nm and less than or equal to 10 μm, greater than or equal to 500 nm and less than or equal to 5 μm, greater than or equal to 500 nm and less than or equal to 1 μm, greater than or equal to 1 μm and less than or equal to 10 μm, greater than or equal to 1 μm and less than or equal to 5 μm, or greater than or equal to 5 μm and less than or equal to 10 μm.

The blackness M_{y} of the composite material 500 is, in embodiments, greater than or equal to 125 and less than or equal to 300. In some embodiments, the composite material 500 may have a blackness My that is greater than or equal to 125 and less than or equal to 165, such as greater than or equal to 130 and less than or equal to 160, greater than or equal to 135 and less than or equal to 155, greater than or equal to 140 and less than or equal to 150, greater than or equal to 145 and less than or equal to 165, greater than or equal to 145 and less than or equal to 160, greater than or equal to 155 and less than or equal to 165, greater than or equal to 160 and less than or equal to 165, or greater than or equal to 150 and less than or equal to 160. In some embodiments, the composite material 500 may have a blackness My that is greater than or equal to 155 and less than or equal to 240, such as greater than or equal to 160 and less than or equal to 230, greater than or equal to 170 and less than or equal to 210, greater than or equal to 180 and less than or equal to 200, greater than or equal to 190 and less than or equal to 240, greater than or equal to 195 and less than or equal to 230, greater than or equal to 210 and less than or equal to 240, greater than or equal to 170 and less than or equal to 205, or greater than or equal to 200 and less than or equal to 215. In other embodiments, the composite material 500 may have a blackness My that is greater than or equal to 230 and less than or equal to 300, such as greater than or equal to 230 and less than or equal to 275, greater than or equal to 230 and less than or equal to 250, greater than or equal to 240 and less than or equal to 280, greater than or equal to 240 and less than or equal to 260, greater than or equal to 250 and less than or equal to 300, greater than or equal to 250 and less than or equal to 280, greater than or equal to 260 and less than or equal to 295, greater than or equal to 260 and less than or equal to 280, greater than or equal to 270 and less than or equal to 300, greater than or equal to 270 and less than or equal to 285, or greater than or equal to 280 and less than or equal to 300.

In embodiments, the composite material 500 may have a reflectivity in the visible spectrum of electromagnetic radiation (from 350 nm to 750 nm) that is less than or equal to 10%, such as less than or equal to 9%, less than or equal to 8%, less than or equal to 7%, less than or equal to 6%, less than or equal to 5%, less than or equal to 4%, less than or equal to 3%, less than or equal to 2%, less than or equal to 1%, or less than or equal to 0.5%.

In embodiments, the composite material 500 may have a reflectivity in the near-IR and LiDAR spectrum of electromagnetic radiation (from 800 nm to 2500 nm) that is greater than or equal to 12%, such as greater than or equal to 15%, greater than or equal to 20%, greater than or equal to 25%, greater than or equal to 30%, or greater than or equal to 35%. In one or more embodiments, the composite material may have a reflectivity in the near-IR and LiDAR spectrum of electromagnetic radiation (from 800 nm to 2500 nm) that is greater than or equal to 12% and less than or equal to 30%, such as greater than or equal to 15% and less than or equal to 30%, greater than or equal to 20% and less than or equal to 30%, or greater than or equal to 25% and less than or equal to 30%, greater than or equal to 12% and less than or equal to 25%, greater than or equal to 15% and less than or equal to 25%, greater than or equal to 20% and less than or equal to 25%, greater than or equal to 12% and less than or equal to 20%, greater than or equal to 15% and less than or equal to 20%, or greater than or equal to 12% and less than or equal to 15%.

With reference now to FIG. 6, a composite material 600 according to one or more embodiments comprises a core 610 infused with the copper oxide crystallites 615 according to embodiment disclosed and described herein and a tinted shell 620. Although FIG. 6 shows a cross section of a spherical composite material 600, the geometry of composite material according to embodiments should not be so limited and composite materials 600 according to embodiments disclosed and described herein may have any geometry.

Broad-spectrum electromagnetic radiation 630, which includes visible, near-IR, and LiDAR electromagnetic radiation, is incident to the composite material 600. At least the near-IR and LiDAR electromagnetic radiation of the broad-spectrum electromagnetic radiation 630 passes through the shell 620 and is incident to the copper oxide crystallites 615 in the core 610 where the near-IR and LiDAR electromagnetic radiation 631 is reflected by the copper oxide crystallites 615. In embodiments, the shell may reflect a portion of electromagnetic radiation in the visible spectrum so as to give a viewer an appearance of color emanating from the composite material. Because the core of composite material of embodiments depicted in FIG. 6 comprises the dark-colored copper oxide crystallites disclosed and described herein, the composite material of the embodiments depicted in FIG. 6 may have a dark color. For instance, if the tinted material in the shell 620 is a shade of blue, because the core 610 of the composite material 600 comprises the dark-colored copper oxide crystallites 615 disclosed and described herein, the composite material 600 will have a dark blue appearance. Thus. the composite material 600 of embodiments depicted in FIG. 6 can be used to provide a dark-colored material that also reflects near-IR and LiDAR electromagnetic radiation, which is not achievable using white-colored near-IR and LiDAR reflecting materials (such as white TiO₂).

To form the core 610, copper oxide crystallites 615 are infused into any core material 611 that allows at least near-IR electromagnetic radiation and LiDAR electromagnetic radiation to be incident to the copper oxide crystallites 615 infused therein. In one or more embodiments, the core material 611 is a transparent material. The core material 611 may be, in embodiments, a plastic, such as polyethylene terephthalate (PET), acrylonitrile butadiene styrene (ABS), polypropylene, polyethylene, polyvinyl chloride (PVC), polystyrene, combinations thereof, and the like.

In embodiments, the core 610 may be infused with greater than or equal to 0.10 mass % CuO crystallites or infused with greater than or equal to 0.1 mass % and less than or equal to 22 mass % of the copper oxide crystallites based on the total weight of the core, such as greater than or equal to 0.1 mass % and less than or equal to 5 mass % of the copper oxide crystallites, greater than or equal to 0.5 mass % and less than or equal to 5.5 mass % of the copper oxide crystallites, greater than or equal to 1.5 mass % and less than or equal to 6 mass % of the copper oxide crystallites, greater than or equal to 2.0 mass % and less than or equal to 6.5 mass % of the copper oxide crystallites, greater than or equal to 3 mass % and less than or equal to 7 mass % of the copper oxide crystallites, greater than or equal to 4 mass % and less than or equal to 7.5 mass % of the copper oxide crystallites, greater than or equal to 1.5 mass % and less than or equal to 4.5 mass % of the copper oxide crystallites, greater than or equal to 2.0 mass % and less than or equal to 5 mass % of the copper oxide crystallites, greater than or equal to 3.0 mass % and less than or equal to 5.5 mass % of the copper oxide crystallites, greater than or equal to 2 mass % and less than or equal to 4 mass % of the copper oxide crystallites, greater than or equal to 2.5 mass % and less than or equal to 4.5 mass % of the copper oxide crystallites, greater than or equal to 1 mass % and less than or equal to 18 mass % of the copper oxide crystallites, greater than or equal to 1 mass % and less than or equal to 12 mass % of the copper oxide crystallites, greater than or equal to 1 mass % and less than or equal to 5 mass % of the copper oxide crystallites, greater than or equal to 5 mass % and less than or equal to 20 mass % of the copper oxide crystallites, greater than or equal to 5 mass % and less than or equal to 12 mass % of the copper oxide crystallites, greater than or equal to 10 mass % and less than or equal to 22 mass % of the copper oxide crystallites, greater than or equal to 10 mass % and less than or equal to 18 mass % of the copper oxide crystallites, greater than or equal to 15 mass % and less than or equal to 22 mass % of the copper oxide crystallites, or greater than or equal to 18 mass % and less than or equal to 22 mass % of the copper oxide crystallites.

The shell 620 may comprise a tinted material. In embodiments, the tinted material may be epoxy, polyurethane, polyacrylic, lacquer, and combinations thereof tinted with an organic or inorganic colorant. In embodiments, the tinted material may be a plastic, such as polyethylene terephthalate (PET), acrylonitrile butadiene styrene (ABS), polypropylene, polyethylene, polyvinyl chloride (PVC), polystyrene, combinations thereof, and the like tinted with an organic or inorganic colorant. It should be understood that the type and amount of the colorant present in the tinted material is not particularly limited and may be adjusted to provide a desired visual effect to the composite material; however, the amount of colorant in the tinted material comprising the shell 620 should not be so high that broad-spectrum radiation cannot traverse through the shell 620 and to the core 610 of the composite material.

In one or more embodiments, the shell 620 may have a thickness that is greater than or equal to 5 nm to less than or equal to 40 μm, such as greater than or equal to 5 nm and less than or equal to 20 μm, greater than or equal to 5 nm and less than or equal to 10 μm, greater than or equal to 5 nm and less than or equal to 1 μm, greater than or equal to 5 nm and less than or equal to 500 nm, greater than or equal to 5 nm and less than or equal to 200 nm, greater than or equal to 5 nm and less than or equal to 100 nm, greater than or equal to 5 nm and less than or equal to 50 nm, greater than or equal to 50 nm to less than or equal to 40 μm, greater than or equal to 50 nm and less than or equal to 20 μm, greater than or equal to 50 nm and less than or equal to 10 μm, greater than or equal to 50 nm and less than or equal to 1 μm, greater than or equal to 50 nm and less than or equal to 500 nm, greater than or equal to 50 nm and less than or equal to 200 nm, greater than or equal to 200 nm to less than or equal to 40 μm, greater than or equal to 200 nm and less than or equal to 20 μm, greater than or equal to 200 nm and less than or equal to 10 μm, greater than or equal to 200 nm and less than or equal to 1 μm, greater than or equal to 200 nm and less than or equal to 500 nm, greater than or equal to 500 nm to less than or equal to 40 μm, greater than or equal to 500 nm and less than or equal to 20 μm, greater than or equal to 500 nm and less than or equal to 10 μm, greater than or equal to 500 nm and less than or equal to 1 μm, greater than or equal to 1 μm to less than or equal to 40 μm, greater than or equal to 1 μm and less than or equal to 20 μm, greater than or equal to 1 μm and less than or equal to 10 μm, greater than or equal to 1 μm and less than or equal to 5 μm, greater than or equal to 5 μm to less than or equal to 40 μm, greater than or equal to 5 μm and less than or equal to 20 μm, greater than or equal to 5 μm and less than or equal to 10 μm, greater than or equal to 10 μm to less than or equal to 40 μm, greater than or equal to 10 μm and less than or equal to 20 μm, or greater than or equal to 20 μm to less than or equal to 40 μm.

In embodiments, the composite material 600 may have a reflectivity in the near-IR and LiDAR spectrum of electromagnetic radiation (from 800 nm to 2500 nm) that is greater than or equal to 12%, such as greater than or equal to 15%, greater than or equal to 20%, greater than or equal to 25%, greater than or equal to 30%, or greater than or equal to 35%. In one or more embodiments, the composite material may have a reflectivity in the near-IR and LiDAR spectrum of electromagnetic radiation (from 800 nm to 2500 nm) that is greater than or equal to 12% and less than or equal to 30%, such as greater than or equal to 15% and less than or equal to 30%, greater than or equal to 20% and less than or equal to 30%, or greater than or equal to 25% and less than or equal to 30%, greater than or equal to 12% and less than or equal to 25%, greater than or equal to 15% and less than or equal to 25%, greater than or equal to 20% and less than or equal to 25%, greater than or equal to 12% and less than or equal to 20%, greater than or equal to 15% and less than or equal to 20%, or greater than or equal to 12% and less than or equal to 15%.

With reference now to FIG. 7, a composite material 700 according to one or more embodiments comprises a core 710 infused with the copper oxide crystallites 715 according to embodiment disclosed and described herein and a clear shell 720. Although FIG. 6 shows a cross section of a spherical composite material 700, the geometry of composite material according to embodiments should not be so limited and composite materials 700 according to embodiments disclosed and described herein may have any geometry.

Broad-spectrum electromagnetic radiation 730, which includes visible, near-IR, and LiDAR electromagnetic radiation, is incident to the composite material 700 and traverses through the shell 720 to be incident to the copper oxide crystallites 715 where electromagnetic radiation in the visible spectrum is absorbed by the copper oxide crystallites 715 while near-IR and LiDAR electromagnetic radiation 731 is reflected by the copper oxide crystallites 715. The composite material of the embodiments depicted in FIG. 7 has a dark black color as nearly all the electromagnetic radiation in the visible spectrum is absorbed the copper oxide crystallites 715 present in the core 710 of the composite material 700. The composite material 700 of embodiments depicted in FIG. 7 can use less copper oxide crystallites 715 to achieve a high level of blackness than if only copper oxide crystallites were used, and still have significant reflectance of near-IR or LiDAR electromagnetic radiation. The composite material 700 of embodiments depicted in FIG. 7 can also protect the copper oxide crystallites 715 and allow improved integration of dark-colored near-IR and LiDAR reflective colorants into other materials where integration of the copper oxide crystallites is difficult. This can reduce the cost of producing a near-IR or LiDAR reflective black material when compared to using copper oxide crystallites alone, and can produce a composite material that has better blackness than copper oxide crystallites used alone.

To form the core 710, copper oxide crystallites 715 are infused into any core material 711 that allows at least near-IR electromagnetic radiation and LiDAR electromagnetic radiation to be incident to the copper oxide crystallites 715 infused therein. In one or more embodiments, the core material 711 is a transparent material. The core material 711 may be, in embodiments, a plastic, such as polyethylene terephthalate (PET), acrylonitrile butadiene styrene (ABS), polypropylene, polyethylene, polyvinyl chloride (PVC), polystyrene, combinations thereof, and the like.

In embodiments, the core 710 may be infused with greater than or equal to 0.10 mass % CuO crystallites or infused with greater than or equal to 0.1 mass % and less than or equal to 22 mass % of the copper oxide crystallites based on the total weight of the core, such as greater than or equal to 0.1 mass % and less than or equal to 5 mass % of the copper oxide crystallites, greater than or equal to 0.5 mass % and less than or equal to 5.5 mass % of the copper oxide crystallites, greater than or equal to 1.5 mass % and less than or equal to 6 mass % of the copper oxide crystallites, greater than or equal to 2.0 mass % and less than or equal to 6.5 mass % of the copper oxide crystallites, greater than or equal to 3 mass % and less than or equal to 7 mass % of the copper oxide crystallites, greater than or equal to 4 mass % and less than or equal to 7.5 mass % of the copper oxide crystallites, greater than or equal to 1.5 mass % and less than or equal to 4.5 mass % of the copper oxide crystallites, greater than or equal to 2.0 mass % and less than or equal to 5 mass % of the copper oxide crystallites, greater than or equal to 3.0 mass % and less than or equal to 5.5 mass % of the copper oxide crystallites, greater than or equal to 2 mass % and less than or equal to 4 mass % of the copper oxide crystallites, greater than or equal to 2.5 mass % and less than or equal to 4.5 mass % of the copper oxide crystallites, greater than or equal to 1 mass % and less than or equal to 18 mass % of the copper oxide crystallites, greater than or equal to 1 mass % and less than or equal to 12 mass % of the copper oxide crystallites, greater than or equal to 1 mass % and less than or equal to 5 mass % of the copper oxide crystallites, greater than or equal to 5 mass % and less than or equal to 20 mass % of the copper oxide crystallites, greater than or equal to 5 mass % and less than or equal to 12 mass % of the copper oxide crystallites, greater than or equal to 10 mass % and less than or equal to 22 mass % of the copper oxide crystallites, greater than or equal to 10 mass % and less than or equal to 18 mass % of the copper oxide crystallites, greater than or equal to 15 mass % and less than or equal to 22 mass % of the copper oxide crystallites, or greater than or equal to 18 mass % and less than or equal to 22 mass % of the copper oxide crystallites.

The shell 720 may comprise any clear coat material, such as epoxy, polyurethane, polyacrylic, lacquer, and combinations thereof. In embodiments, the shell may be a plastic, such as polyethylene terephthalate (PET), acrylonitrile butadiene styrene (ABS), polypropylene, polyethylene, polyvinyl chloride (PVC), polystyrene, combinations thereof, and the like.

In one or more embodiments, the shell 720 may have a thickness that is greater than or equal to 20 nm and less than or equal to 5 μm, such as greater than or equal to 20 nm and less than or equal to 1 μm, greater than or equal to 20 nm and less than or equal to 500 nm, greater than or equal to 20 nm and less than or equal to 300 nm, greater than or equal to 20 nm and less than or equal to 150 nm, greater than or equal to 75 nm and less than or equal to 5 μm, greater than or equal to 75 nm and less than or equal to 1 μm, greater than or equal to 75 nm and less than or equal to 500 nm, greater than or equal to 75 nm and less than or equal to 300 nm, greater than or equal to 75 nm and less than or equal to 150 nm, greater than or equal to 100 nm and less than or equal to 500 nm, greater than or equal to 100 nm and less than or equal to 300 nm, greater than or equal to 300 nm and less than or equal to 5 μm, greater than or equal to 300 nm and less than or equal to 1 μm, greater than or equal to 300 nm and less than or equal to 500 nm, greater than or equal to 500 nm and less than or equal to 5 μm, greater than or equal to 500 nm and less than or equal to 1 μm, or greater than or equal to 1 μm and less than or equal to 5 μm.

The blackness M_{y} of the composite material 700 is, in embodiments, greater than or equal to 125 and less than or equal to 300. In some embodiments, the composite material 700 may have a blackness My that is greater than or equal to 125 and less than or equal to 165, such as greater than or equal to 130 and less than or equal to 160, greater than or equal to 135 and less than or equal to 155, greater than or equal to 140 and less than or equal to 150, greater than or equal to 145 and less than or equal to 165, greater than or equal to 145 and less than or equal to 160, greater than or equal to 155 and less than or equal to 165, greater than or equal to 160 and less than or equal to 165, or greater than or equal to 150 and less than or equal to 160. In some embodiments, the composite material 700 may have a blackness My that is greater than or equal to 155 and less than or equal to 240, such as greater than or equal to 160 and less than or equal to 230, greater than or equal to 170 and less than or equal to 210, greater than or equal to 180 and less than or equal to 200, greater than or equal to 190 and less than or equal to 240, greater than or equal to 195 and less than or equal to 230, greater than or equal to 210 and less than or equal to 240, greater than or equal to 170 and less than or equal to 205, or greater than or equal to 200 and less than or equal to 215. In other embodiments, the composite material 700 may have a blackness My that is greater than or equal to 230 and less than or equal to 300, such as greater than or equal to 230 and less than or equal to 275, greater than or equal to 230 and less than or equal to 250, greater than or equal to 240 and less than or equal to 280, greater than or equal to 240 and less than or equal to 260, greater than or equal to 250 and less than or equal to 300, greater than or equal to 250 and less than or equal to 280, greater than or equal to 260 and less than or equal to 295, greater than or equal to 260 and less than or equal to 280, greater than or equal to 270 and less than or equal to 300, greater than or equal to 270 and less than or equal to 285, or greater than or equal to 280 and less than or equal to 300.

In embodiments, the composite material 700 may have a reflectivity in the visible spectrum of electromagnetic radiation (from 350 nm to 750 nm) that is less than or equal to 10%, such as less than or equal to 9%, less than or equal to 8%, less than or equal to 7%, less than or equal to 6%, less than or equal to 5%, less than or equal to 4%, less than or equal to 3%, less than or equal to 2%, less than or equal to 1%, or less than or equal to 0.5%.

In embodiments, the composite material 700 may have a reflectivity in the near-IR and LiDAR spectrum of electromagnetic radiation (from 800 nm to 2500 nm) that is greater than or equal to 12%, such as greater than or equal to 15%, greater than or equal to 20%, greater than or equal to 25%, greater than or equal to 30%, or greater than or equal to 35%. In one or more embodiments, the composite material may have a reflectivity in the near-IR and LiDAR spectrum of electromagnetic radiation (from 800 nm to 2500 nm) that is greater than or equal to 12% and less than or equal to 30%, such as greater than or equal to 15% and less than or equal to 30%, greater than or equal to 20% and less than or equal to 30%, or greater than or equal to 25% and less than or equal to 30%, greater than or equal to 12% and less than or equal to 25%, greater than or equal to 15% and less than or equal to 25%, greater than or equal to 20% and less than or equal to 25%, greater than or equal to 12% and less than or equal to 20%, greater than or equal to 15% and less than or equal to 20%, or greater than or equal to 12% and less than or equal to 15%.

As would be understood from the foregoing, composite materials according to embodiments disclosed and described herein offer an effective solution to replace traditional carbon black pigments in the future autonomous environment. Copper oxide crystallites show superior blackness in the visible region while keeping infrared reflectivity.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A composite material comprising:
a core, and
a shell at least partially encompassing the core, wherein
at least one of the core and the shell comprises copper oxide crystallites, and
the composite material comprises:
a reflectivity in the visible spectrum of electromagnetic radiation that is less than or equal to 10.0%, and
a reflectivity in the near-IR and LiDAR spectrum of electromagnetic radiation that is greater than or equal to 12%.

2. The composite material of claim 1, wherein the copper oxide crystallites are present in the core.

3. The composite material of claim 1, wherein the copper oxide crystallites are present in the shell.

4. The composite material of claim 3, wherein the core comprises a black-colored material.

5. The composite material of claim 4, wherein the core comprises carbon black.

6. The composite material of claim 1, wherein the copper oxide crystallites have an average particle size that is greater than or equal to 5 nm and less than or equal to 15 nm.

7. The composite material of claim 1, wherein the copper oxide crystallites comprise:
a ratio of (−111)/(111) greater than or equal to 0.5 and less than or equal to 1.5; and
a blackness My greater than or equal to 130 and less than or equal to 170.

8. The composite material of claim 1, wherein the copper oxide crystallites are infused to at least one of the core and the shell in an amount that is greater than or equal to 0.1% and less than or equal to 22% by mass.

9. The composite material of claim 1, wherein the core comprises a plastic selected from the group consisting of polyethylene terephthalate (PET), acrylonitrile butadiene styrene (ABS), polypropylene, polyethylene, polyvinyl chloride (PVC), polystyrene, and combinations thereof.

10. The composite material of claim 1, wherein the shell comprises a clear coat selected from the group consisting of epoxy, polyurethane, polyacrylic, lacquer, and combinations thereof.

11. The composite material of claim 1, wherein the shell comprises a plastic selected from the group consisting of polyethylene terephthalate (PET), acrylonitrile butadiene styrene (ABS), polypropylene, polyethylene, polyvinyl chloride (PVC), polystyrene, and combinations thereof.

12. The composite material of claim 1, wherein the shell has a thickness that is greater than or equal to 5 nm and less than or equal to 40 μm.

13. The composite material of claim 1, wherein the composite material comprise a blackness M_{y} that is greater than or equal to 125 and less than or equal to 300.

14. A composite material comprising:
a core comprising copper oxide crystallites, and
a shell at least partially encompassing the core, wherein
the shell comprises a colorant, and
the composite material comprises a reflectivity in the near-IR and LiDAR spectrum of electromagnetic radiation that is greater than or equal to 12%.

15. The composite material of claim 14, wherein the copper oxide crystallites have an average particle size that is greater than or equal to 5 nm and less than or equal to 15 nm.

16. The composite material of claim 14, wherein the copper oxide crystallites comprise:
a ratio of (−111)/(111) greater than or equal to 0.5 and less than or equal to 1.5; and
a blackness My greater than or equal to 130 and less than or equal to 170.

17. The composite material of claim 14, wherein the copper oxide crystallites are infused into the core in an amount that is greater than or equal to 0.1% and less than or equal to 22% by mass.

18. The composite material of claim 14, wherein the core comprises a plastic selected from the group consisting of polyethylene terephthalate (PET), acrylonitrile butadiene styrene (ABS), polypropylene, polyethylene, polyvinyl chloride (PVC), polystyrene, and combinations thereof.

19. The composite material of claim 14, wherein the shell comprises a clear coat selected from the group consisting of epoxy, polyurethane, polyacrylic, lacquer, and combinations thereof.

20. The composite material of claim 14, wherein the shell comprises a plastic selected from the group consisting of polyethylene terephthalate (PET), acrylonitrile butadiene styrene (ABS), polypropylene, polyethylene, polyvinyl chloride (PVC), polystyrene, and combinations thereof.

21. The composite material of claim 14, wherein the shell has a thickness that is greater than or equal to 5 nm and less than or equal to 40 μm.
